(19) United States
(12) Patent Application Publication
(10) Pub. No.: US 2009/0234483 A1
(43) Pub. Date: Sep. 17, 2009

(54) Remote Access Unit and Method for Managing Welding Devices Connected to a Network Via Interfaces

(76) Inventors: Tomas Leko, Wels (AT); Markus Pernegger, Eberstalzell (AT); Manuel Rumpl, Sipbachzell (AT); Roland Schick, Sattledt (AT); Markus Stöger, Vorchdorf (AT); Manfred Wittmann, Rutzenmoos (AT)

Correspondence Address: COLLARD & ROE, P.C., 1077 NORTHERN BOULEVARD, ROSLYN, NY, 11576, US

(21) Appl. No.: 11/990,238

(22) PCT Filed: Sep. 7, 2006
(86) PCT No.: PCT/AT2006/000373

§ 371 Date: Feb. 8, 2008

(30) Foreign Application Priority Data
Sep. 9, 2005 (AT) A 1478/2005

(51) Int. Cl. G06F 17/00; G06F 3/048; G06F 3/041

(52) U.S. Cl. 700/110; 715/738; 715/702; 715/772; 700/212

(57) ABSTRACT

The invention describes a remote access unit (31) and a method for managing welding devices (1) which are connected to a network (27) via interfaces (28), including a connection for connecting to the network (27), a display for displaying the welding devices (1) and their parameters and/or configurations, a memory for storing the parameters and/or configurations of the welding devices (1), and input units for operation. For creating such a remote access unit (31) for optimally managing welding devices (1), it is provided that the display is designed as a central graphical surface for displaying any number of welding devices (1) as a function of paths, which are assigned to the welding devices (1), as well for displaying their parameters and configurations, and in that a module is provided for comparing the parameters and/or configurations stored to the current parameters and/or configurations of the welding devices (1), and in that the display is designed for displaying the differences between the current and the stored parameters and/or configurations of the welding devices (1).

The invention relates to a remote access unit for managing welding devices connected to a network via interfaces, comprising a connection for connecting to the network, a display for displaying the welding devices and their parameters and/or configurations, a memory for storing the parameters and/or configurations of the welding devices, and input units for operating. Furthermore, the invention relates to a method for communication between at least one remote access unit and at least one welding device which is provided in the network and includes at least one current source, a control device and an interface to the network, wherein the remote access unit is designed for managing the welding devices and comprises a memory for storing the parameters and/or configurations of the welding devices.

Apparatuses for managing welding devices which are connected with each other via a network are known from the prior art, by means of which a welding device can be adjusted by a remote access unit via the network. For example, it is known from U.S. Pat. No. 6,479,792 B that a welding device which is connected to the network can be configured via a computer which is also connected to the network, i.e. via a remote access unit. For this purpose, an appropriate software has been installed on the computer.

A software for configuration of welding devices is known from U.S. Pat. No. 6,744,011 B1, which has been installed on an appropriate computer. The computer comprises a monitor, on which a graphical surface of the software is displayed. This surface serves for the purpose of monitoring a welding process in a so-called window and for storing the welding parameters for quality control. Likewise, the welding parameters displayed on the graphical surface can be appropriately defined by the user of the software. For monitoring several welding processes at the same time, the user of the software must accordingly open more windows. Here, the disadvantage is that the number of the welding devices and welding processes which are to be monitored at the same time and which are present in the network is limited since a separate window has to be displayed on the monitor for each welding process. Thus, only those welding devices, in particular their operational states, can be monitored whose parameters are displayed on the monitor. Furthermore, the parameters of the welding devices which are monitored by the software cannot be displayed in a clear manner by means of the software.

The object of the invention resides in providing a remote access unit for managing welding devices, by the aid of which any number of welding devices can be detected, managed, configured and displayed.

The object of the invention is achieved in that the display is designed as a central graphical surface for displaying any number of welding devices, which are connected to and/or activated in the network, as a function of paths assigned to the welding devices, as well as for displaying their parameters and configurations, and in that a module is provided for comparing the parameters and/or configurations stored with the current parameters and/or configurations of the welding devices, and in that the display is designed for displaying the differences between the current and the stored parameters and/or configurations of the welding devices. Here, it is advantageous that any number of welding devices can be displayed in a clear manner and can be configured. Likewise, it is achieved by the central graphical surface that no switch-over between different windows is necessary. It is also advantageous that the software module stores the configurations and/or parameters of the welding devices, whereby a comparison of the configurations and/or parameters stored with the current configuration of the respective welding device can be done. In case that such a comparison results in differences, these are advantageously displayed for the user of the software module in a clear manner with graphical support, and the user may decide which configuration the welding device shall use.

According to a further feature of the invention, a unit is provided for detection of the welding devices connected to or activated in the network.

By the measure that the central graphical surface is divided into several navigation areas, it is advantageously achieved that a simple switch-over between the welding devices to be configured is possible. Likewise, a new welding device can be selected at any time. This is additionally facilitated in an advantageous manner by assigning the welding devices to the areas.

By the measure that the navigation area is divided into several levels for configuration of a welding device, configuration is facilitated and additionally, clarity of the central graphical surface is increased.

Advantageously, it is achieved by the measure of storing the history of the changes in configuration that the changes in the configuration of a welding device can be reconstructed at any time.

The use of navigation elements is also advantageous, by which clarity of the central graphical surface is increased.

By the measure that the configuration of the welding device can be automatically stored in the remote access unit via the software module and can correspondingly be again input into at least one welding device, downtime of a welding device can be advantageously shortened since the configuration stored can be input into the welding device at any time, whereby an error search is rendered unnecessary.

It is also advantageous that in the symbols, by means of which the welding devices are displayed in the navigation areas, the state of the welding devices is indicated, whereby the state of the welding devices displayed in the navigation areas can be seen immediately.

A further object of the invention resides in providing one of the above methods for communication between at least one remote access unit and at least one welding device arranged in a network, by means of which differences in the configuration of the welding devices and in the respective stored back-up of the configuration can be detected and displayed in a clear manner.

This further object of the invention is achieved in that any number of welding devices connected to or activated in the network as well as their parameters and/or configurations can be displayed as a function of paths which are assigned to the welding devices, and in that the stored parameters and/or configurations of the welding devices are compared with the current parameters and/or configuration of the welding devices as soon as an already known welding device is connected and/or activated or as soon as a user starts a comparison, and in that the differences between the current and the stored parameters and/or configurations of the welding devices are displayed. Here, it is advantageous that the time needed for the error search can be substantially reduced by the comparison of the configurations, and the differences between the configurations can be seen immediately. It is of advantage that any number of welding devices can be detected, whereby any number of welding devices can be added to the network, without the need for changes in the process.

By the measure that welding devices added to the network are automatically detected by the software module, it is achieved that no configuration of the software module is necessary.

By the measure that the back-ups of the configurations of the welding devices are timely controlled and can likewise again be input into the respective welding devices, it is achieved in an advantageous manner that the time needed for maintenance is substantially reduced.

Likewise, maintenance efforts are minimised by the measure that an update of the software is timely controlled in the welding device and is done for several welding devices at the same time.

The present invention will be explained in more detail by way of the enclosed schematic drawings.

Therein:

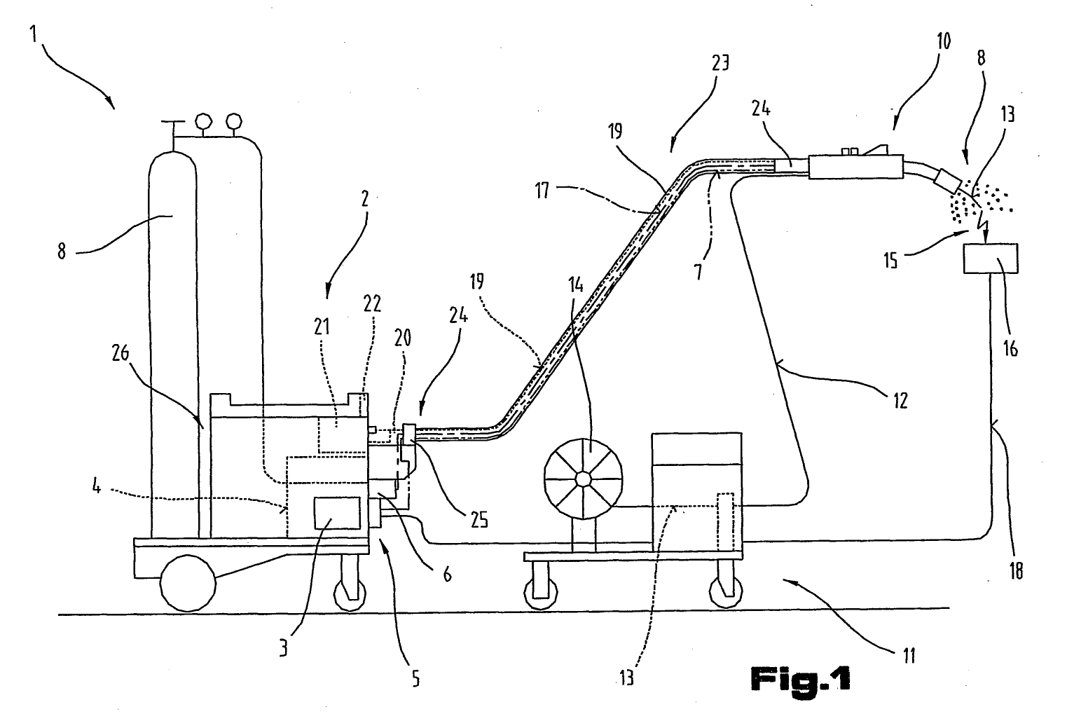

FIG. 1 shows an exemplary representation of a welding machine or a welding device;

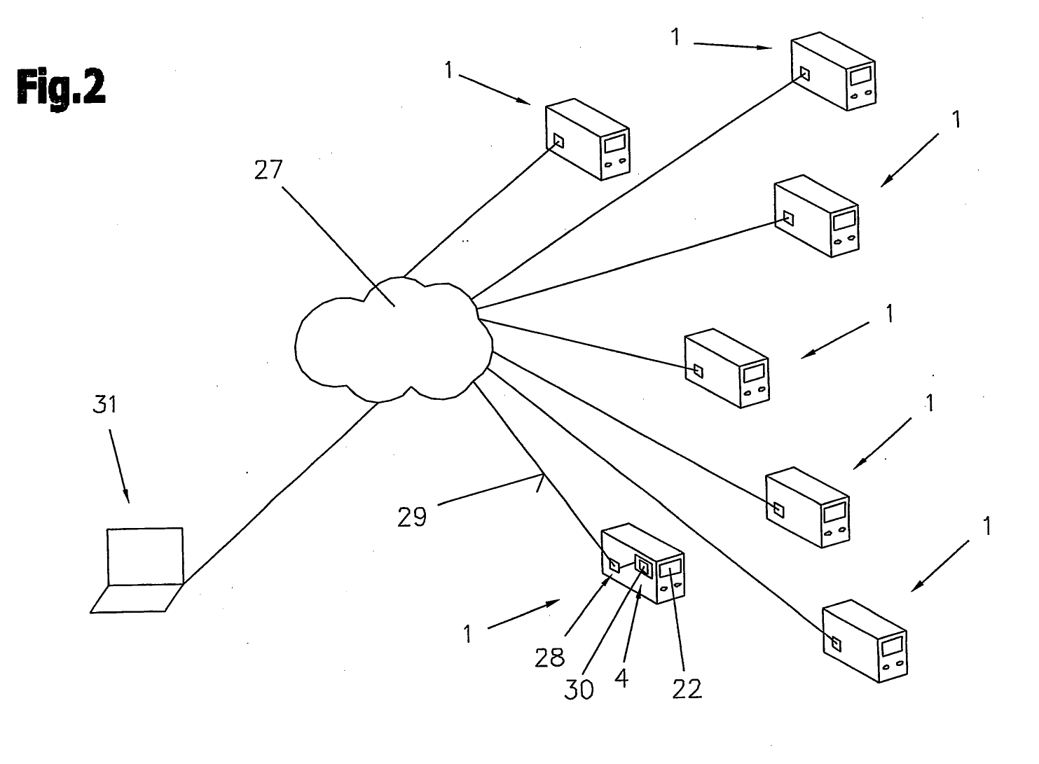

FIG. 2 shows an exemplary representation of several welding devices which are connected with each other via a network; and

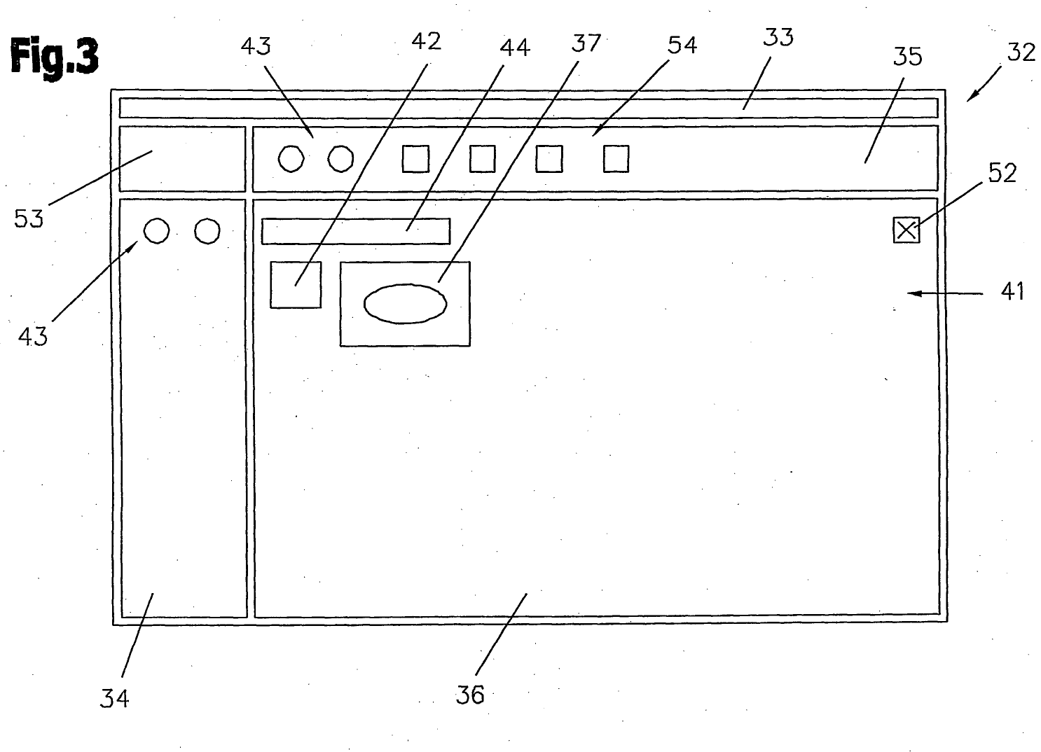

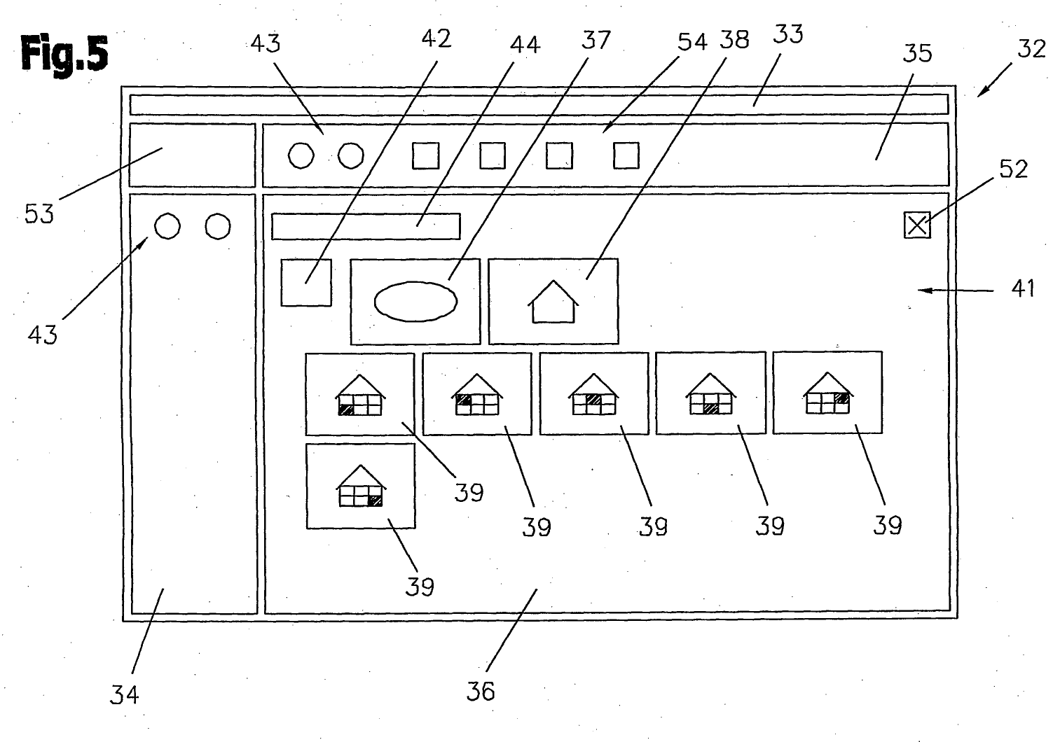

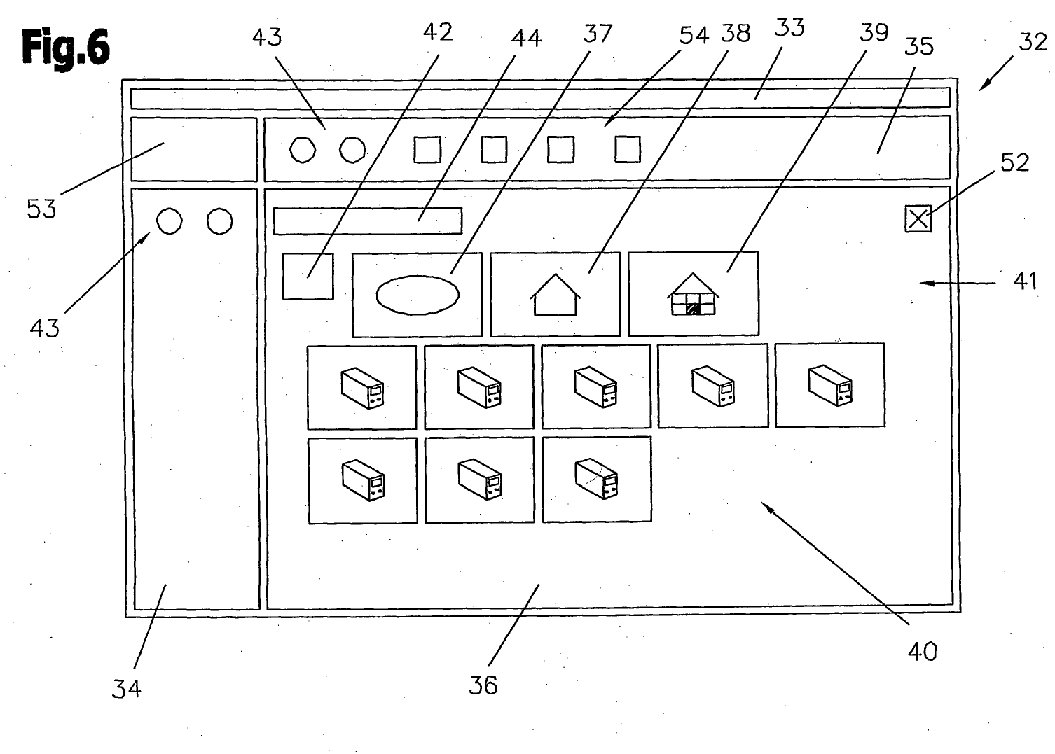

FIGS. 3 to 7 show different exemplary representations of the inventive central graphical surface of the software module.

Initially, it is pointed out that identical parts of the exemplary embodiments are denoted by the same reference numbers.

In FIG. 1, there is shown a welding device 1 or a welding plant for the most different processes and methods, such as, e.g. MIG/MAG welding and WIG/TIG welding, or electrode-welding methods, double-wire/tandem welding methods, plasma or soldering methods, etc.

The welding device 1 comprises a current source 2 with a power element 3, a control device 4 and a switching member 5 which is assigned to the power element 3 and/or the control device 4. The switching member 5 and/or the control device 4 is/are connected with a control valve 6 which is arranged in a supply line 7 for a gas 8, in particular a protective gas, such as, e.g. CO₂, helium or argon and the like, between a gas reservoir 9 and a welding torch 10 or a torch.

Moreover, a wire feeder 11 which is common for MIG/MAG welding, can be additionally activated via the control device 4, wherein a filler and/or a welding wire 13 is supplied from a feed drum 14 or a wire coil to the region of the welding torch 10 via a supply line 12. Of course, it is possible that the wire feeder 11 is integrated in the welding device 1, in particular in the basic housing, as known from the prior art, instead of being designed as an accessory device as illustrated in FIG. 1.

It is also possible that the wire feeder 11 supplies the welding wire 13 and/or filler from outside of the welding torch 10 to the location of processing, wherein, to this end, a non-consumable electrode is preferably arranged in the welding torch 10, as is common with WIG/TIG welding.

The current for establishing an electric arc 15, in particular an electric work arc, between the non-consumable electrode (not illustrated), and a workpiece 16 is supplied from the power element 3 of the current source 2 to the welding torch 10, in particular the electrode, via a welding line 17, wherein the workpiece 16 to be welded, which is formed of several parts, is also connected with the welding device 1, in particular with the current source 2, via a further welding line 18, and, thus, an electric circuit can be established for a process via the electric arc 15 and/or the plasma jet formed.

For cooling the welding torch 10, the welding torch 10 can be connected with a liquid reservoir, in particular a water reservoir 21, via a cooling circuit 19, a flow monitor 20 being interposed, whereby the cooling circuit 19, in particular a liquid pump used for the liquid provided in the water reservoir 21, is started when the welding torch 10 is put into operation and, thus, cooling of the welding torch 10 can be effected.

The welding device 1 further comprises an input and/or output device 22, via which the most different welding parameters, modes of operation or welding programmes of the welding device 1 can be set or called. Here, the welding parameters, modes of operation or welding programmes set via the input and/or output device 22 are forwarded to the control device 4 and, subsequently, the latter activates the individual components of the welding plant or welding device 1 and/or determines the corresponding command values for control thereof.

Moreover, in the exemplary embodiment illustrated, the welding torch 10 is connected with the welding device 1 or the welding plant via a hose package 23. The individual lines extending from the welding device 1 to the welding torch 10 are arranged in the hose package 23. The hose package 23 is connected with the welding torch 10 via a coupling device 24, whereas the individual lines provided in the hose package 23 are connected with the individual contacts of the welding device 1 via jacks or plug-in connectors. In order to ensure an appropriate strain relief of the hose package 23, the hose package 23 is connected with a housing 26, in particular with the basic housing of the welding device 1, via a strain-relief device 25. Certainly, it is possible that the coupling device 24 is also used for the connection provided on the welding torch 1.

Basically, it has to be stated that not all of the components mentioned above can or must be used for the different welding methods and/or welding devices 1, such as, e.g. WIG devices or MIG/MAG devices or plasma devices. For this purpose it is possible, e.g. for the welding torch 10 to be designed as an air-cooled welding torch 10.

In FIG. 2, several welding devices 1 are illustrated which are connected with each other via a network 27. To this end, an interface 28 is integrated in the welding devices 1, as known from the prior art, which interface allows for a connection of the welding devices 1 with the network 27. The connection is established, e.g. via a network cable 29, a so-called LAN cable. Likewise, the interface 28 is connected with the control device 4 of the welding device 1. The control device 4 is in particular formed of a microprocessor 30 which controls a welding process. To this end, the microprocessor 30 detects all settings adjusted via the input and/or output device 22. Likewise, the microprocessor 30 can detect the settings necessary for a welding process via the interface 28 and receive them via the network 27. Thus, a remote access to one and/or several welding device(s) 1 is enabled via the network 27. The remote access is established via a remote access unit 31 connected to the network 27, preferably via a computer. An appropriate software and/or software module has been installed on the remote access unit 31 which allow(s) for remote access to the welding devices 1. Basically, the welding parameters for a welding process can be set and monitored via the remote access.

In order to be able to transfer the adjusted settings of the software for a welding process to the microprocessor 30 of the welding device 1, a connection has to be established. To this end, an address, e.g. the so-called IP address, which is unique in the network, has been assigned to the welding devices 1. This address has been preset by the producer of the welding device 1, e.g., and can also be adapted to the network 27 by the user of the welding device 1. In order to establish a connection, this unique address must also be known to the software. This is achieved, e.g. in that the unique address is added to the software or in that the welding device 1 requests the address from the software. Thus, a connection can be established between the microprocessor 30 of the welding device 1 and the remote access unit 31. Then, using this connection in the network 27, the adjusted settings of the software for a welding process, e.g. referring to the TCP/IP protocol known, can be transferred to the microprocessor 30 via the interface 28 provided in the welding device 1.

It is likewise possible that the software allows for additional functions, e.g. for displaying the operational state of the welding device 1, an error monitoring, a documentation of welding processes, changes in the software of the welding device 1, and similar functions.

A so-called window serves for configuration of a welding device via the software, in which window the welding parameters for a welding process are displayed and can be selected and changed accordingly. To this end, several sub-windows are integrated in the window. Likewise, a sub-window may serve for the graphical display of a welding parameter during a welding process. If the user of the software is to monitor several welding processes at the same time, he accordingly has to open many windows. As a clear representation on a monitor of the remote access unit 31 shall be provided, the number of windows is limited, whereby also the number of welding devices 1 is limited.

According to the invention, the software for remote access is expanded such that any number of welding devices 1 can be detected in the network 27 and such that they are displayed on a central graphical surface 32 for configuration, management and operation. Likewise, the central graphical surface 32 of the software allows for displaying several welding devices 1 at the same time, whereby configuration of interrelated welding systems is facilitated.

In FIG. 3, the central graphical surface 32 is schematically illustrated at the point of time the software is started.

It can be seen from FIG. 3 that the graphical surface 32 is divided into several navigation areas 33 to 36. Preferably, the surface 32 is divided into a navigation area 33 which extends horizontally on the upper rim of the central graphical surface 32, into a navigation area 34 which is provided in a vertical direction on the left side of the surface 32, into a navigation area 35 which forms a crossbeam in the upper region of the graphical surface 32, and into a navigation area 36 which takes up most of the region of the graphical surface 32. Thus, the central graphical surface 32, i.e. the software, can be used for configuration, management and operation of all welding devices 1 present in the network 27.

To this end, the welding devices 1 present in the network 27 must be known to the software, this is why the software is configured. Here, the software receives the information as to which welding devices 1 are connected to the network 27 and which shall be managed by their software. Basically, it is sufficient for this purpose to provide the software with an address or a name of the welding device 1. This address or name is unique in the network 27, whereby a welding device 1 can be unambiguously identified, e.g. by the IP address or the serial number of the welding device 1. Of course, this address is also assigned to the respective welding device 1.

Likewise, it is also possible that a new welding device 1 is automatically detected in the network 27, e.g. by an appropriately configured network 27. Thus, the software can communicate with the welding devices 1 in the network 27, and data can be exchanged. To this end, the software starts, e.g. in certain intervals a request whether or not new welding devices 1 have been connected to the network. If the software detects new welding devices 1, these will be displayed for the user in the navigation area 36. At the same time the software also checks whether all welding devices 1 are in smooth or in faulty operation so that the state of the welding devices 1 can be updated.

The communication between the software and the welding device 1 is visualised by cooperation of the individual navigation areas 33 to 36.

The navigation area 33 displays a menu bar including different setting options and menu items, such as, e.g. “FILE, SETTINGS, USER”. The settings to be adjusted here are general settings which apply to all navigation areas 33 to 36 and welding devices 1 in the network 27, e.g. allocation of rights for the individual users of the software or indication of storage locations on the remote access unit 31.

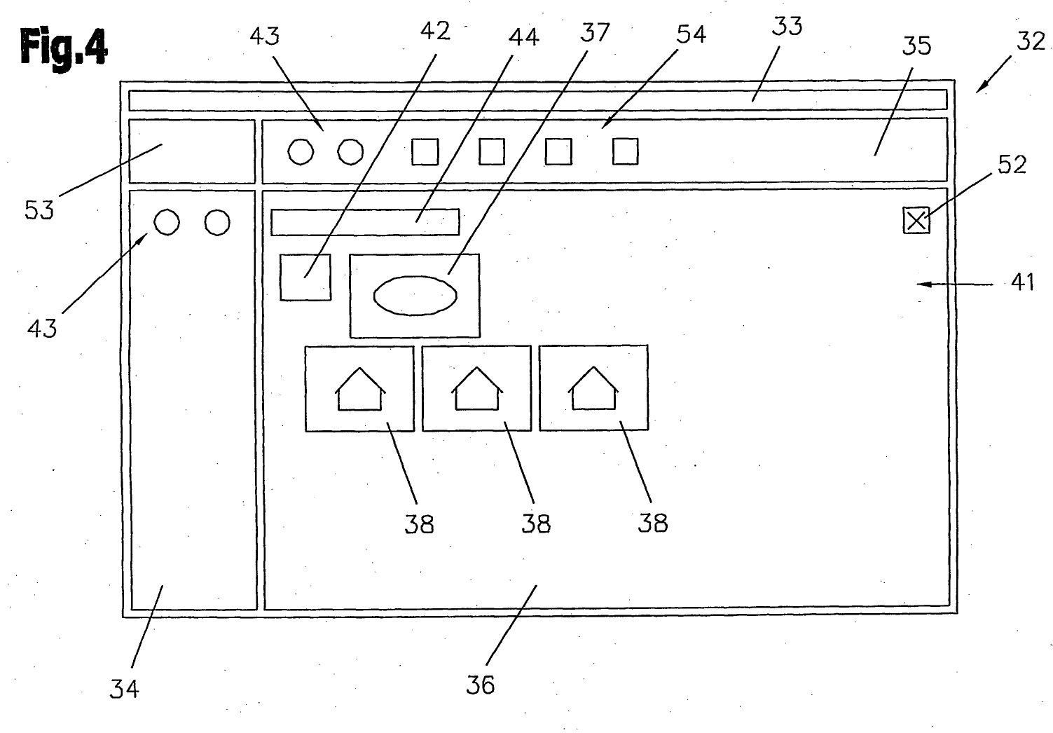

On the one hand, the navigation area 36 serves for selecting a welding device 1 and, on the other hand, for detailed configuration of a welding device 1. Thus, the navigation area 36 serves for displaying two different views, i.e. the navigation area 36, in particular the representation of the navigation area 36, can be adapted and changed appropriately. This can be seen from FIGS. 4 to 6.

After the software has been started, at least one symbol for the producer 37 will be displayed in the navigation area 36. Thus, it is advantageously achieved that the software can also be used for different offices of a large company. After selecting the producer 37, e.g. via a touchscreen, symbols for the production halls 38 of the producer 37 will be displayed therebelow. After the respective production halls 38 have been selected, the production halls 38 will be replaced by symbols for the areas 39 into which the production hall 38 selected is divided. If a selection is made according to one of the areas 39, symbols 40 for the welding devices 1 present in the selected area 39 will replace the areas 39. A so-called path 41, i.e. the position where the welding device 1 desired is provided, i.e. the symbols, producer 37, production hall 38 and the area 39, will be displayed in the upper region of the navigation area 36 in a horizontal direction. Of course, it is possible to define the path 41 more precisely, that is, e.g. the areas 39 are once more divided into sub-areas and are accordingly included in the sub-areas of the welding devices 1. Thus, the welding device(s) 1 desired can be selected from the welding devices 1 assigned to the area 39, each of said welding devices 1 being represented below the path 41 by a symbol 40.

If the welding device 1 desired is not in the area 39 selected or if the user-wants to get back to the starting window according to FIG. 3, it can be switched to the level of the producer 39 by selecting a respective symbol 42 according to FIG. 3. Thus, the welding device 1 desired can again be searched for, using the above procedure. Likewise, it is possible that, e.g. by selecting the production hall 38 in the path 41, a different area 39 will be selected within this production hall 38. Certainly, it is also possible that the welding device 1 desired is selected via a search function (not illustrated) integrated in the navigation area 36.

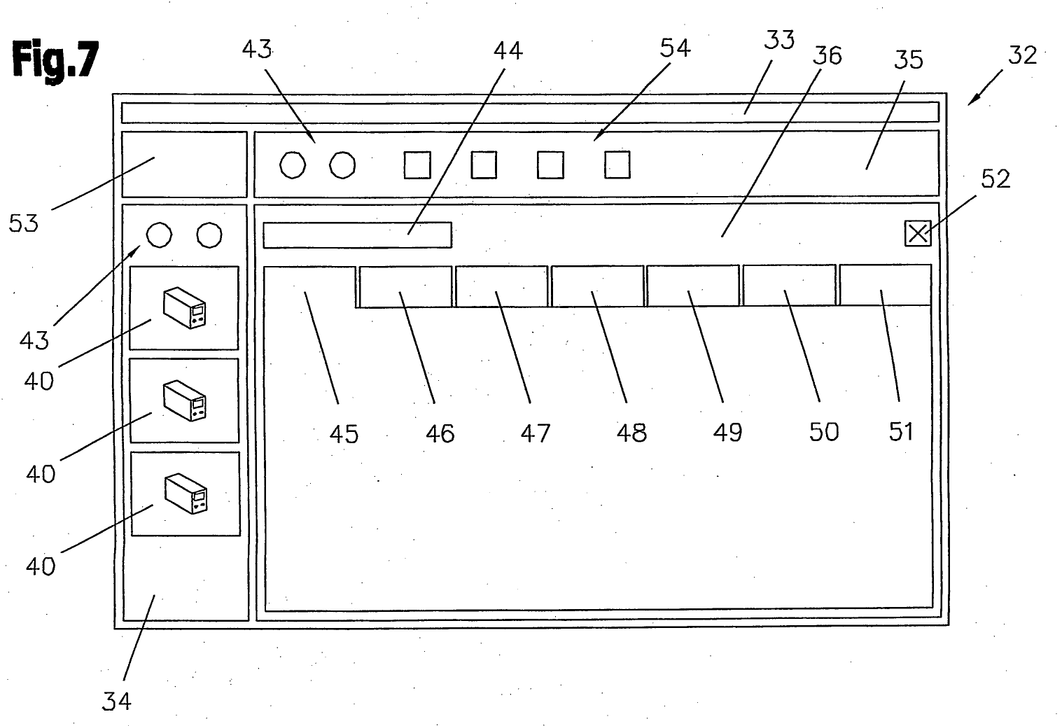

After the welding device 1 has been selected, said welding device will be displayed by the symbol 40 in the navigation area 34, as illustrated in FIG. 7.

The navigation area 34 serves for displaying and selecting those welding devices 1 which are currently being adapted and/or configured by the user, that is, the user selects the respective welding devices 1 in the navigation area 36 and these are then transferred to the navigation area 34. At the same time the operational state is displayed in the symbol 42 for each welding device 1 in the navigation area 34, i.e. whether the welding device 1 has been activated or deactivated or is online or offline. Preferably, the operational state of the welding devices 1 is illustrated in a circle. For example, there is a checkmark in the circle when the welding device 1 is online and there is a cross in the circle when the welding device 1 is offline. Likewise this representation can be supported by colours, e.g. with a green circle for an activated welding device 1 and with a red circle for a deactivated welding device 1. Of course, it is also possible that the operational states are displayed in this manner in the navigation area 36 in the symbols 40. Furthermore, two navigation elements 43 are provided in the navigation area 34, by the aid of which the symbols 40, i.e. the welding devices 1, can be moved preferably in a vertical direction. Thus, the navigation area 34 does not depend on the number of welding devices 1 which are being adapted and illustrated at the same point of time. To this end, a text will be displayed in the navigation area 34, e.g. below the navigation elements 43, which includes the number of all welding devices 1 which are currently to be adapted.

If a welding device 1, i.e. a symbol 40, is selected from the navigation area 34, several levels 45 to 51 will appear in the navigation area 36 of the central graphical surface 32 of the software. These levels 45 to 51 serve for adaptation and detailed configuration of a welding device 1 selected. To this end, for example, the navigation area 36 is divided into the levels “overview” 45, “panel” 46, “jobs” 47, “documentation” 48, “logbook” 49, “statistics” 50 and “diagrams” 51. Likewise, the denomination of the welding device 1 selected is displayed in the navigation area 36 in a window 44 and the respective symbol 40 is graphically changed in the navigation area 34. For example, the background colour of the symbol 40 is changed, whereby it differs from the other symbols 40 displayed in the navigation area 34.

After the respective welding device 1 has been selected from the navigation area 36, the levels 45 to 51 will also be displayed, wherein only the content of one of the levels 45 to 51 can be seen and settings can be adjusted accordingly. Of course, any of the other levels 45 to 51 can be selected at any time, and its content can be displayed for configuration.

In the level “overview” 45, detailed information on the respective welding device 1 is given, preferably the denomination of the welding device 1, the unique address, the operational state, maintenance data, hours of operation, technical data on the welding device 1 and a graphical representation of the welding device 1. Likewise, a field for notes is provided in the level “overview” 45 so that one or more user(s) of the software can take and read important notes or the like.

Likewise, the level “overview” 45 allows for the back-up of the current settings and configuration of the respective welding device 1. A back-up of the setting and of the data of all levels 45 to 51 of a welding device 1 is effected, e.g. by selecting a respective symbol in the level “overview” 45. Likewise, it is possible that a point of time and/or time intervals can be set, at/in which a data back-up shall be done. Thus, the data back-up is done in an automated manner. The corresponding data are transferred, e.g. via the network 27 to the remote access unit 31, and are stored as a so-called “snap-shot”. The “snap-shot” remains stored even when the respective welding device 1 is taken from the network 27 or turned off, i.e. is offline. It is thus achieved that a so-called online-offline comparison can be done, as will be explained in more detail below. Likewise, a previous back-up of a welding device 1 can be input into the same or another via a respective symbol in the level “overview” 45, i.e. a so-called data restore can be done. Such a restore can, of course, also be done for several welding devices 1 at the same time.

The level “panel” 46 serves for configuration of the welding parameters, e.g. welding current, welding voltage, wire-feeding rate, etc., for a welding process. Preferably, the level “panel” 46 is displayed in a way that the graphical surface substantially corresponds to the surface of the input/output device 22 on the welding device 1. Likewise, the same settings can be done as on the input/output device 22. Variations of the welding parameters during a welding process can also be observed in the level “panel” 46. For example, configuration of the welding device 1 can be appropriately changed and wrong settings can be corrected.

In the level “jobs” 47, the jobs, i.e. defined job steps which the respective welding device 1 follows in a defined order for producing a defined workpiece 16, are displayed. To this end, the content of the level “jobs” 47 is divided, e.g. into two vertical columns. In the left column those jobs are illustrated which have been generated for the respective welding device 1 or which have been copied by a different welding device 1. If a job is selected, the respective welding parameters of the job will be displayed in the right column. Likewise, these welding parameters can be appropriately changed. Corresponding symbols are provided in the level “jobs” 47 for copying, generating or modifying jobs for one or several welding device(s) 1. Another symbol serves for storing the corresponding jobs, e.g. Likewise, the software detects when on the welding device 1 on the input/output device 22, a welding parameter is changed during an ongoing job in the welding device 1. This is also detected as soon as the welding device 1 is connected to the network and is turned on, i.e. is idling, and a welding parameter is changed on the welding device 1. This is correspondingly displayed in the level “jobs” 47 at the respective job, e.g. by a colour mark. This is done, e.g. by marking the respective job with a yellow point. Likewise, it is also possible that changes in a job are represented by a notification on the monitor of the remote access unit 31. After the jobs marked have been selected, the changed welding parameters provided in the right column will be likewise colour-marked. The welding parameters changed can be accepted or amended appropriately by the user of the software. This is done via corresponding symbols provided in the level “jobs” 47.

The jobs are marked in the same way when a difference between the snap-shot stored and the jobs in the welding device 1 is detected by the software, i.e. when an online-offline comparison is made. This online-offline comparison is started automatically by the software as soon as the software recognizes an already known welding device 1 which is again connected to the network 27. Said recognition is based on the serial number and/or the address of the welding device 1, of which a snap-shot is stored. If the software detects differences in the settings of the parameters, i.e. welding parameters, and/or in the configuration of the welding device 1, this is correspondingly shown with the jobs. Accordingly, the user can subsequently decide on the basis of the symbols provided in the level “jobs” 47 whether configuration of the welding device 1 shall remain the same, whether the configuration stored in the software shall be transferred to, and input into, the welding device 1 or whether the user of the software reconfigures the welding device 1 or adapts the settings and/or configuration of the welding device 1. Of course, it is also possible that the online-offline comparison is started manually by the user, e.g. via a respective symbol provided in the level “jobs” 47.

Likewise, the online-offline comparison can be made by a service technician who connects, e.g. a laptop, on which the appropriate software has been installed and the snap-shots have been stored, to the network 27. Thus, the service technician can eliminate welding errors in a simple manner, since the difference between the welding parameters in the welding device 1 and the snap-shot can immediately be seen in the level “jobs” 47 thanks to the online-offline comparison.

In the level “documentation” 48, the respective welding parameters, such as command and actual values of current, voltage, gas, rate of the welding wire 13, etc., referring to a conducted welding process, are stored and documented. To this end, e.g. a corresponding pull-down menu is provided in the level “documentation” 48, by means of which different kinds of detailed information can be displayed. For example, the items “welds”, “section”, “error”, “actual values” and “command values” can be selected via the pull-down menu. Under the item “welds” all general data of a welding process, such as date, time, average welding current, etc., are displayed. Under the item “section” the history of a welding process, i.e. the different phases, are displayed in a detailed manner with the corresponding welding parameters. The item “error” shows alarm and error notifications. Under the item “actual values”, variation of the welding parameters during a welding process can be observed and displayed. Here, for example, the corresponding welding parameters, such as current and voltage, are displayed for every 100 msec.

The level “logbook” 49 serves for storing the most essential changes in a welding device 1. Here, for example, all alarm and error notifications are stored, it is stored at which time which user successfully or unsuccessfully logged in the welding device 1, and the history of a job is stored and displayed. In the job history it is shown in a detailed way which user of the software changed which welding parameter of a certain job at which point of time. This can be displayed by means of the items “error”, “event job change” and “event user change”, which can be selected by a pull-down menu in the level “logbook” 49.

The level “statistics” 50 serves for detecting statistical values of a welding process. For example, a limit for a welding parameter can be set for a welding process so that, e.g. a certain welding-current maximum must not be exceeded. If this is nevertheless the case, these limit exceedances, that is, e.g. a preset welding-current maximum has been exceeded, are correspondingly displayed and stored in the level “statistics” 50. These data can also be used for assessing quality of a weld.

In the level “diagrams” 51, certain welding parameters which are detected in the levels “documentation” 48 and “statistics” 50 can be displayed graphically. This can also be observed during the ongoing welding process of one or several welding device(s) 1, whereby, e.g. limit exceedances can be immediately detected and used for establishing limits.

Of course, the number of levels 45 to 51 in the navigation area 36 is not limited. If the number of the levels 45 to 51 is higher than the number of levels 45 to 51 displayable in the navigation area 36, the levels 45 to 51 can be moved in a horizontal direction, e.g. by appropriate navigation elements 43, as already described with respect to the navigation area 34. Instead of the additional navigation elements 43 or additionally thereto, the graphical representation of the levels 45 to 51 can likewise be changed, e.g. by providing less room for each of the levels 45 to 51, whereby accordingly more levels 45 to 51 can be displayed in the navigation area 36.

After the settings and/or configurations of the welding device 1 has/have been done successfully in all levels 45 to 51, these are correspondingly stored. Thus, the operational state of the welding device 1 is changed in the symbol 40 in the navigation area 34 if the welding device 1 was deactivated or had an error.

Thereafter, the window in which a welding device 1 in the navigation area 36 is displayed can be correspondingly closed via a symbol 52, e.g. a cross within a square. Thus, the symbol 40 for the respective welding device 1 disappears from the navigation area 34. After a window has been closed, the, e.g. last-adapted welding device 1 in the navigation area 36 appears, which is displayed in the navigation area 34 and can be adapted accordingly.

For adapting a new welding device 1, i.e. a welding device 1 which has so far not been present in the navigation area 34, the view has to be changed in the navigation area 36. This is done via a respective symbol 53 which includes, e.g. the text “browse” and is preferably provided in the upper left corner of the central graphical surface 32. Thus, the levels 45 to 51 are hidden in the navigation area 36, and the starting window is opened according to FIG. 3. Thus, the welding device 1 desired can be selected by selecting the respective area 39 in the production hall 38 of the producer 37.

Selection of a certain welding device 1 is done, e.g. via the input units of the remote access unit 31, i.e. via a mouse or a keyboard, or via a so-called touchscreen. To this end, the symbols 40 for the welding devices 1, the symbols for the producer 37, the production hall 38, the area 39, etc., as well as the levels 45 to 51 are correspondingly designed.

The navigation area 35 serves for arranging respective symbols 54, by means of which, e.g. the changes made in one of the levels 45 to 51 in the navigation area 36 can be stored. Likewise, a symbol 54, e.g. can be used for transferring the configuration of a welding device 1 to another welding device 1. Another symbol 54 in the navigation area 35 can be used for changing the software of a welding device 1 and for updating the software. This can likewise be done for several similar welding devices 1 at the same time, whereby the time needed for an update is reduced. Likewise, this procedure can be timely controlled, whereby an update of the software of one and/or several welding device(s) 1 can be done in an automated way.

Likewise, additional documents and information can be stored in the software, e.g. construction figures of the workpieces 16 to be produced, descriptions, detailed documentations on the welding device 1, etc. These documents and information are appropriately assigned to a welding device 1, a job or the like, via a link. A link present for a welding device 1 is marked, e.g. by an additional element in the symbol 40, e.g. by a notepad.

The links can also be used for illustrating the components of a welding device 1 graphically by a stored representation. This is possible since the connected components, such as welding torch 10 and wire feeder 11, are known to the control device 4 of the welding device 1. These data can be read by the control device 4 via the network 27 and can be correspondingly displayed on the monitor of the remote access unit 31.

Additionally, the components of a welding device 1 can be checked for their function and wear. For example, based on the hours of operation of the welding device 1 and/or the welding torch 10, it can be calculated when the wearing parts are to be exchanged. For example, if the wear falls short of a certain threshold value, the software will generate an alarm notification. Likewise, the residual amount of the welding wire 13 can be detected in this manner, which the software can appropriately react to. In the same way the function and/or the operational state of the components of the welding device 1 can be checked.

1-25. (canceled)

26. Remote access unit (31) for managing welding devices (1) connected to a network (27) via interfaces (28), comprising a connection for connecting to the network (27), a display for displaying the welding devices (1) and their parameters and/or configurations, a memory for storing the parameters and/or configurations of the welding devices (1), and input units for operating, wherein the display is designed as a central graphical surface (32) for displaying any number of welding devices (1), which are connected to and/or activated in the network (27), as a function of paths (41) assigned to the welding devices (1), as well as for displaying their parameters and configurations, and in that a module is provided for comparing the parameters and/or configurations stored with the current parameters and/or configurations of the welding devices (1), and in that the display is designed for displaying the differences between the current and stored parameters and/or configurations of the welding devices (1), and in that a unit is arranged for detecting the welding devices (1) which are connected to, and/or activated in, the network (27).

27. Remote access unit (31) according to claim 26, wherein the central graphical surface (32) has several navigation areas (33 to 36) within a window.

28. Remote access unit (31) according to claim 27, wherein a navigation area (33) is designed as a menu bar with at least one menu item for general settings of the further navigation areas (34 to 36).

29. Remote access unit (31) according to claim 26, wherein the welding devices (1) present in the network (27) are assigned to different areas (39).

30. Remote access unit (31) according to claim 27, wherein a further navigation area (36) is designed for selection of at least one welding device (1) and for configuration of one of the welding devices (1) selected.

31. Remote access unit (31) according to claim 30, wherein the selection of a welding device (1) in the navigation area (36) is divided into several steps, in particular into producer (37), production hall (38) and areas (39).

32. Remote access unit (31) according to claim 30, wherein a navigation area (36) is designed for selection and configuration of the welding devices (1) and is divided into several levels (45 to 51), in particular into the levels overview (45), panel (46), jobs (47), documentation (48), logbook (49), statistics (50) and diagrams (51).

33. Remote access unit (31) according to claim 27, wherein a welding device (1) is displayed as a symbol (40) in the navigation areas (33 to 36).

34. Remote access unit (31) according to claim 27, wherein a further navigation area (34) is designed for displaying of the welding devices (1) which are currently being configured, and in that the symbols (40) are selectable.

35. Remote access unit (31) according to claim 34, wherein at least the denomination, a graphical representation and the state of the welding devices (1) are displayed in the symbols (40).

36. Remote access unit (31) according to claim 27, wherein a further navigation area (35) is designed for configuration of several welding devices at the same time.

37. Remote access unit (31) according to claim 27, wherein a search function is integrated in at least one of the navigation areas (33 to 36).

38. Remote access unit (31) according to claim 27, wherein at least one navigation element (43) is provided in the navigation areas (33 to 36) for moving and displaying invisible elements, such as the symbols (40) or the levels (45 to 51).

39. Remote access unit (31) according to claim 27, wherein the input units for operating the elements displayed in the navigation areas (33 to 36), such as the symbols (40) or the levels (45 to 51), are formed by a computer mouse or a keyboard.

40. Remote access unit (31) according to claim 27, wherein the input units for operating the elements displayed in the navigation areas (33 to 36), such as the symbols (40) or the levels (45 to 51), are formed by a touchscreen display.

41. Remote access unit (31) according to claim 26, wherein the interface (28) of the welding device (1) has an identification unique in the network (27).

42. Method for communication between at least one remote access unit (31) and at least one welding device (1) provided in a network (27), with at least one current source (2), a control device (4) and an interface (28) to the network (27), wherein the remote access unit (31) is designed for managing the welding devices (1) and comprises a memory for storing the parameters and/or configurations of the welding devices (1), wherein any number of welding devices (1), which are connected to, and/or activated in, the network (27) as well their parameters and configurations are displayed as a function of paths (41) assigned to the welding devices (1), and in that the stored parameters and/or configurations of the welding devices (1) are compared with the current parameters and/or configurations of the welding devices (1) as soon as an already known welding device (1) is being connected and/or activated or a comparison is being started by a user, and in that the differences between the current and the stored parameters and/or configurations of the welding devices (1) are displayed, and in that new welding devices (1) connected to, or activated in, the network (27) are automatically detected and inserted into the central graphical surface (32).

43. Method according to claim 42, wherein the configuration in the welding device (1) is backed up automatically after a defined point of time or periodically.

44. Method according to claim 42, wherein the stored parameters and/or configurations of at least one welding device (1) are transferred to at least one welding device (1) in a timely controlled manner.

45. Method according to claim 44, wherein the stored parameters and/or configurations of at least one welding device (1) are transferred to several welding devices (1) at the same time.

46. Method according to claim 42, wherein a software for the control device (4) of at least one welding device (1) is updated in a timely controlled manner.

47. Method according to claim 42, wherein the detailed history of changes made in the parameters and/or configurations of the welding devices (1) is displayed and/or stored.

48. Method according to claim 42, wherein the operational state of the welding devices (1) is displayed.
